(19) United States
(12) Patent Application Publication
(10) Pub. No.: US 2022/0402816 A1
(43) Pub. Date: Dec. 22, 2022

(54) METHOD FOR DECORATIVELY MARKING GLASS ARTICLES AT HIGH TEMPERATURE BY LASER

(71) Applicant: SAVERGLASS, Feuquieres (FR)

(72) Inventors: Frédéric DUPUIS, Haute Epine (FR); Maddly FAURIE, Grandvilliers (FR)

(21) Appl. No.: 17/764,135

(22) PCT Filed: Sep. 25, 2020
(86) PCT No.: PCT/FR2020/051680

§ 371 Date: Mar. 25, 2022

(30) Foreign Application Priority Data
Sep. 26, 2019 (FR) 1910633
Nov. 15, 2019 (FR) 1912791

(51) Int. Cl. C03C 23/00; B23K 26/0622; B23K 26/364; B23K 26/402; B23K 26/08; B44C 1/22; C03B 25/06

(52) U.S. Cl. CPC C03C 23/0025; B23K 26/0622; B23K 26/364; B23K 26/402; B23K 26/0823; B44C 1/228; C03B 25/06; B23K 2103/54

(57) ABSTRACT

The invention relates to a method for manufacturing a hollow glass article including a step of marking the hollow glass article thus formed by laser, the surface of the hollow glass article being at a temperature between 400° C. and 600° C. The marking step consists in making filiform decorations by producing at least one continuous and shiny groove on the surface of the hollow glass article.

The invention relates to the field of decoration, personalisation, and marking of glass articles, preferably hollow glass articles.

The production of a relief on the surface of the glass is a known decoration technique that may be implemented in different ways such as for example mechanical etching, mould forming or also acid etching.

Mechanical etching consists in mechanically modifying the surface appearance thanks to etching tools (silicon carbide tip, tungsten carbide, diamond mill, etc.) that come to hollow the glass surface. The decoration operation is generally manual, but may be automated. When this is automated, it requires the implementation of particularly expensive methods (cutting machine, robotised system). This method thus proves to be particularly adapted to products with very high added value (carafes, centrepieces, stem glasses and crystal tumblers for example) or also with the purpose of personalisation. As the etching obtained directly by this method has a matt appearance, obtaining an etching with the shiny appearance requires additional operations of acid or mechanical polishing.

Sandblasting may also be employed, a mask is applied beforehand on the surfaces of the glass article to be protected then sand is projected under pressure in order to locally and mechanically attack the unprotected surface of the glass. The etching obtained has a more or less whitish and more or less matt appearance depending on the particle size distribution and the geometry of the projected sand. However, this method of etching does not make it possible to produce a shiny etching and the definition of the patterns remains limited.

Acid etching may also be implemented. This method also requires the deposition of a mask on the surfaces to be protected prior to the etching step. The article is subsequently immersed in baths of aggressive chemical compositions to obtain shiny, matt or satin etchings. The result obtained by such a process will depend on the nature of the baths, their level of agitation, immersion times of the article and the combination of various dips. Such a process implements extremely dangerous concentrated products (hydrofluoric acid, optionally combined with hydrochloric or sulphuric acid and ammonium bifluoride to obtain satin or matt appearances) and produces significant amounts of effluents (toxic gas emissions and acid rinsing water that should be treated) and this, even for etching thicknesses of a few hundreds of microns. This method further generates large volumes of waste (sludges from the chemical neutralisation of acid rinsing water) that should be recovered in external systems. Consequently, this method proves to be extremely expensive.

It is also possible to modify the surface of a glass article during the forming method thanks to the structure of the forming mould. The appearance of the etching on the glass depends on the quality of the mould and on the parameters of the forming. There are many drawbacks to this method. Indeed, mould removal problems may first of all be encountered if the mould and glass temperatures are not perfectly controlled. Moreover it is very delicate to produce very fine patterns that can be reproduced, the moulds becoming worn and clogged very quickly (with residues of mould removal mineral grease, generally loaded with graphite, or of graphite). In addition, as each decoration etched in the moulds requires more or less pronounced cleaning depending on the height of the targeted relief decoration, this limits the finesse of the etching. The proximity between the patterns and the mould joints may also be detrimental to the mould removal of the articles and generate surface cracks (360° decorations on the body of articles are often difficult or even impossible to produce) without an arrangement of the etching at the mould joints. The technical feasibility of such a method and/or its financial viability is thus often called into question if the production volumes are not sufficiently high.

One aim of the present invention is to meet the drawbacks of the prior art mentioned above and in particular to be able to etch fine and shiny patterns in accordance with the decoration and with the personalisation.

More particularly, one object of the present invention therefore is a method for manufacturing a hollow glass article comprising the following steps:
hot forming the hollow glass article by means of a forming machine,
marking the hollow glass article thus formed by laser, the surface of the hollow glass article being at a temperature between 400° C. and 600° C., and
annealing the hollow glass article thus marked in an annealing lehr; said manufacturing method being characterised in that the marking step consists in making filiform decorations by producing at least one continuous and shiny groove on the surface of the hollow glass article, the groove being defined by a single line, and in that, prior to the marking step, the manufacturing method further includes a step of adjusting the laser consisting in adjusting the laser with the aid:
of a first parameter that is the definition factor, in such a way that the latter is greater than 2.5, the definition factor being defined as the ratio of the product of the diameter of the laser spot (6) with the frequency of the laser (6) and of the scanning speed of the laser (6), and
of a second parameter that is the surface energy, in such a way that the latter is greater than or equal to 0.65 J/mm2, the surface energy being defined as the ratio of the product of the energy of a laser pulse with the frequency of the laser (6) and the product of the diameter of the laser spot (6) with the scanning speed of the laser (6).

Thanks to the invention, it is possible to produce etchings on the surface of hollow glass articles with a laser. The laser is placed at the exit of the forming machine, before the lehr for annealing glass articles. In this area, the glass constituting the hollow glass article is still sufficiently malleable so that the energy provided by the laser can mark the surface of the hollow glass article in order to show a relief etching, visible to the naked eye and shiny.

Advantageously, the laser has a wavelength the rate of absorption of which by the surface of the hollow glass article is greater than 80%, preferably greater than 90%.

Advantageously, the step of adjusting the laser consists in adjusting the laser in such a way that the surface energy is greater than or equal to 0.80 J/mm².

According to other features of the invention, the hollow glass article is made of soda-lime glass. The hollow glass article may be made of crystal glass, or crystalline, or borosilicate or fluorosilicate.

Advantageously, the method for performing the step of marking the hollow glass article is based on the use of a laser of the CO2 type. The luminous energy resulting from the wavelength (10.6 μm) of such a laser will then be absorbed at 90% by the glass, thus causing at least one continuous groove on the surface of the hollow glass article.

According to a first embodiment of the invention, the hollow glass article is placed on a conveyor circulating from the forming step up to the annealing step. The step of marking the hollow glass article is therefore performed on the conveyor and the glass is thus etched directly on the production line.

According to a second embodiment, the method for manufacturing the hollow glass article includes a step of transferring the hollow glass article from the conveyor on ancillary equipment, the marking step being performed on said ancillary equipment.

After the marking step, the hollow glass article resumes its place on the main conveyor. The step of transferring the hollow glass article from the production line to the ancillary equipment thus makes it possible to increase the time dedicated to performing the marking step and to producing a more complex decoration.

Advantageously, the ancillary equipment comprises a carousel.

One object of the present invention also relates to a hollow glass article likely to be obtained by the manufacturing method such as defined according to any one of the preceding features.

Advantageously, the hollow glass article includes at least one continuous and shiny groove produced by the laser on the surface of the hollow glass article having a depth between 25 μm and 30 μm, a width between 300 and 450 μm and two beads of a height between 5 and 7 μm. These features of the continuous groove make it possible to obtain a visible marking.

Other features and advantages of the present invention will become more clearly apparent upon reading the following detailed description for the understanding of which reference will be made to the appended drawings, wherein:

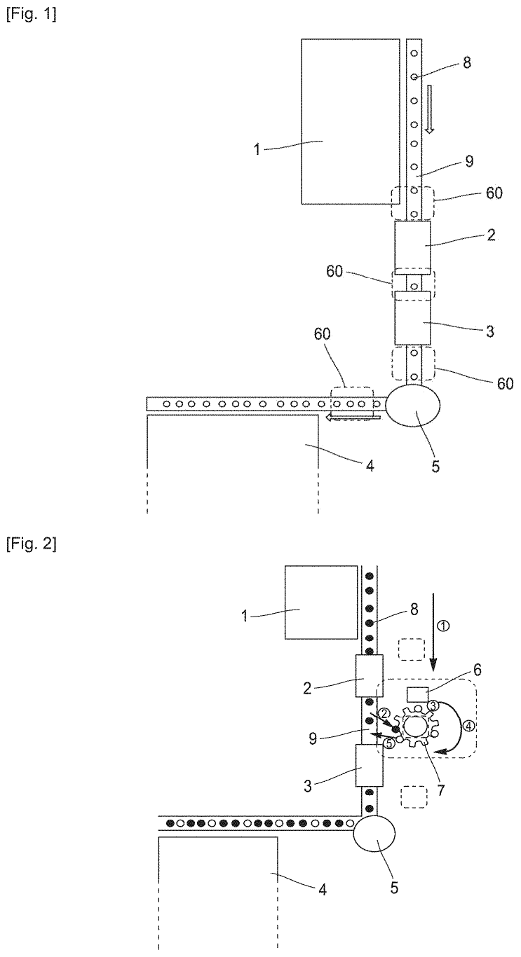

FIG. 1 is a diagram of a production line of the method for manufacturing a hollow glass article according to a first embodiment of the invention, the diagram illustrating various possible locations of the area dedicated to the step of decoratively marking the hollow glass article;

FIG. 2 is a diagram of a production line of the method for manufacturing a hollow glass article comprising a carousel according to a second embodiment of the invention, the diagram illustrating various possible locations of the area dedicated to the step of marking the hollow glass article;

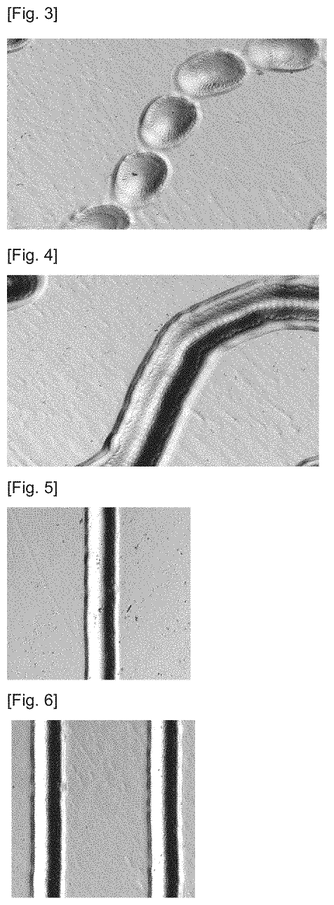

FIG. 3 shows an image obtained with a binocular magnifier of a marking on a hollow glass article produced by a laser the definition factor of which is 0.5 and the surface energy is 0.3 J/mm² (see Example 1);

FIG. 4 shows an image obtained with a binocular magnifier of a marking on a hollow glass article produced by a laser the definition factor of which is 5 and the surface energy is 1.1 J/mm² (see Example 1);

FIG. 5 shows an image obtained with a binocular magnifier of a marking on a hollow glass article produced by a laser, the surface to be treated being placed at the focal plane of the laser (see Example 2);

FIG. 6 shows an image obtained with a binocular magnifier of a marking on a hollow glass article produced by a laser, the surface to be treated being placed at a distance of 10 mm in relation to the focal plane of the laser (see Example 2);

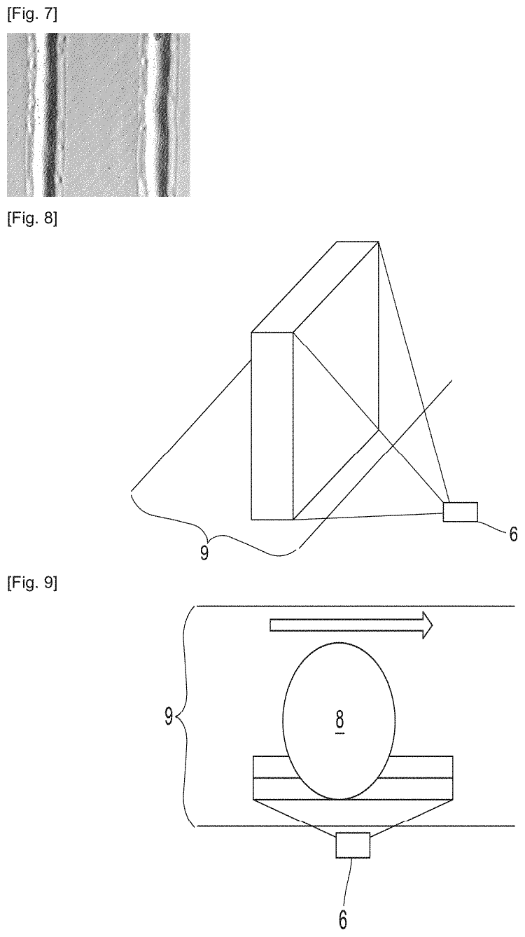

FIG. 7 shows an image obtained with a binocular magnifier of a marking on a hollow glass article produced by a laser, the surface to be treated being placed at a distance of 12 mm in relation to the focal plane of the laser (see Example 2);

FIG. 8 is a perspective schematic view of the marking space of the laser in an area dedicated to the step of marking a hollow glass article by laser (see Example 3);

FIG. 9 is a schematic view of the area dedicated to the step of marking a hollow glass article by laser including a cylindrical hollow glass article positioned to be marked by the laser (see Example 3);

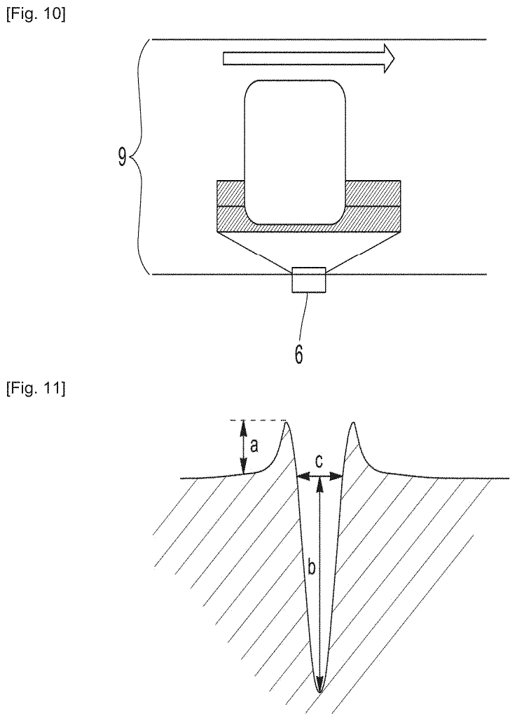

FIG. 10 is a view similar to that of FIG. 9 wherein the hollow glass article ready to be marked is of a square shape (see Example 3);

FIG. 11 is a sectional view of a groove on a hollow glass article obtained by the laser marking step (see Example 4);

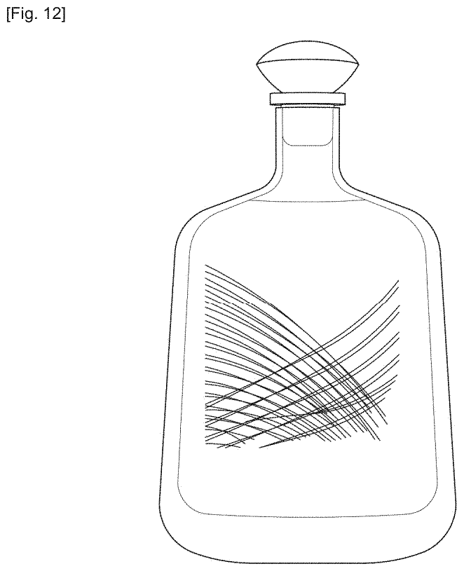

FIG. 12 is a front view of a hollow glass article likely to be obtained by the manufacturing method according to the invention (see Example 4).

FIGS. 1 and 2 present two distinct embodiments of the present invention. These figures are commented on below, whereas FIGS. 3 to 11 are described in detail in the following examples.

According to the two embodiments illustrated in FIGS. 1 and 2, the production line successively comprises:
a forming machine 1 dedicated to the step of hot forming the hollow glass article 8,
a hood for hot treating 2 the hollow glass article 8 thus formed,
a first area 3 dedicated to the Datamatrix marking step,
a transfer wheel 5, and
an annealing lehr 4 dedicated to the step of annealing the hollow glass article 8.

Each hollow glass article 8 is arranged on a conveyor 9 from the forming step up to the annealing step. The conveyor 9 is provided to bring the hollow glass articles 8 from one area to another on the production line.

According the first embodiment illustrated in FIG. 1, the laser decorative marking step is performed directly on the production line, at the exit of the forming machine 1, in a second area 60 dedicated to the laser decorative marking step.

The second area 60 dedicated to the laser decorative marking step may be position according to four different locations:

1. before the hot treatment hood 2,
2. between said hood 2 and the first area 3 dedicated to the Datamatrix marking step,
3. before the transfer wheel 5, or
4. after the transfer wheel 5.

In this first embodiment, the decorative marking step consists in decorating all the hollow glass articles 8 produced during the hot forming step and travelling on the conveyor 9 of the forming machine 1.

In addition, it is possible to provide a plurality of lasers 6 around the hollow glass article 8 in order to mark various faces of the hollow glass article 8 simultaneously.

Consequently, the time attributed to the marking step is imposed by the production rate established on the production line. This may restrict the possible surface to be decorated, that is to say the extent of the etching, according to the space available to locate the lasers 6 and the capacity of the latter (in terms of power and of scanning speed).

According to a second embodiment of the invention illustrated in FIG. 2, the manufacturing method includes ancillary equipment and more particularly a carousel 7.

The laser decorative marking step is performed here outside of the production line, on the ancillary equipment, here the carousel 7. The second area 60 dedicated to the laser decorative marking step is therefore arranged on the carousel 7, this being able to be positioned according to three different locations:

1. before the hot treatment hood 2,
2. between said hot treatment hood 2 and the first area 3 dedicated to the Datamatrix marking step, or
3. before the transfer wheel 5.

In FIG. 2, the second area 60 dedicated to the laser decorative marking step is positioned between the hot treatment hood 2 and the first area 3 dedicated to the Datamatrix marking step. The two other possible arrangements of the second area 60 dedicated to the laser decorative marking step are shown schematically by squares in dotted lines.

According to this second embodiment, the manufacturing method comprises the following steps:
hot forming the hollow glass article by means of a forming machine 1,
linear travelling of the hollow glass articles 8 on the conveyor 9,
transferring the hollow glass article 8 from the conveyor 9 to the ancillary equipment,
marking the hollow glass article 8 by laser, and
transferring the hollow glass article 8 thus marked from the carousel 7 up to the conveyor 9.

In this second embodiment, all or some of the hollow glass articles 8 from the forming machine 1, the surface of which is at a temperature between 400° C. and 600° C., are automatically transferred on ancillary equipment. Consequently, the laser decorative marking step 6 is said to be off-line.

The step of transferring the hollow glass article 8 from the production line to the ancillary equipment thus makes it possible to increase the time dedicated to performing the decorative marking step and to producing a more complex decoration. This makes it possible to also extend the decorated surface while using a plurality of lasers 6 of reasonable power.

The ancillary equipment may for example be designed to select one hollow glass article 8 out of n present on the conveyor 9, for example n is equal to three.

According to one example of embodiment of the invention, the transfer of the hollow glass article 8 from the conveyor 9 to the ancillary equipment and vice versa is carried out by grasping the hollow glass article 8 by the ring thus making it possible not to damage the marking made on the body, the shoulder or the neck of the hollow glass article 8.

During the marking step, the hollow glass article 8 is indexed by a mechanical or optical detection system via a mechanism provided to carry out the alignment of the hollow glass article 8 with the laser(s) 6.

The ancillary equipment may be fixed or carry out a rotation during the marking step. The hollow glass articles 8 may therefore be set in rotation in front of one or more laser(s) 6 thus facilitating the 360° decoration operations.

It is possible to provide a plurality of marking stations around the hollow glass article 8 in order to mark various faces of the hollow glass article 8 simultaneously. For this, these marking stations are arranged on the same ancillary equipment and are supplied either by a single laser source, or by a plurality of laser sources.

In the case of rotary ancillary equipment; the rotation of the hollow glass article 8 is controlled by the laser method 6. The rotation of the ancillary equipment may be continuous or discontinuous and the rotation speed may be variable or constant.

In addition, the ancillary equipment is adapted to limit the mechanical or thermal shocks.

The mode of treating hollow glass articles 8 via ancillary equipment such as a carousel 7 proves to be more complete and complex than the treatment mode performed directly on the production line.

The advantages of using ancillary equipment for performing the step of decoratively marking hollow glass articles 8 are:
the treatment of some of the hollow glass articles 8 produced (1 glass article out of 2, out of 3, out of 4, etc.) makes it possible to benefit from a longer exposure time, therefore to produce more consequent marking surfaces: it partially overcomes production rates,
the rotation of the hollow glass article 8 offers the possibility of decorating the hollow glass article 8 over all of its periphery,
the adjustment of the distance between the surface to be treated of the hollow glass article 8 and the lens makes it possible to increase the available surfaces for the laser marking (it is less restricted by the depth of field of the laser),
the rotation system makes it possible to mark cylindrical hollow glass articles 8 by managing the presence of two mould joints,
the simultaneous marking of a plurality of areas of the hollow glass article 8, or even over 360°, and
the production of a fine and shiny etching that cannot be produced by the hot forming step, and without needing to rework the hollow glass article 8.

However, the implementation of these various treatment modes requires particular adjustments:
a perfect synchronisation with the forming machine 1 in order to ensure the transfer of the hollow glass article 8 from the conveyor 9 to the ancillary equipment,
a perfect synchronisation between the position of the hollow glass article 8 on the ancillary equipment, its orientation and the triggering of laser pulses,
the use of materials adapted to the handling of hot glass, and
the protection of the laser system from nearby heat sources.

A varioscan may also be used in this embodiment: The position of each hollow glass article 8 is determined thanks to a position sensor and the focal length of the laser 6 is automatically adjusted to the position of this article.

The following examples illustrate the marking step of the method for manufacturing a hollow glass article 8 according to the invention, based on FIGS. 3 to 11.

### EXAMPLES

### Example 1: Adjustment of the Physical Parameters of the Laser 6

A plurality of parameters were taken into account for producing a qualitative laser marking on the hollow glass article 8 such as the power, the frequency and the scanning speed of the beam of the laser 6. The optimum parameters were determined experimentally, first of all, by visual assessment, then, with the aid of a binocular magnifier. They were subsequently translated in the form of physical parameters such as for example the energy received by the surface of the glass treated, the definition factor of the etching, the energy of a laser pulse, etc.

Two physical parameters were defined to numerically characterise the marking:
the surface energy: its value makes it possible to determine if the surface of the hollow glass article 8 will be sufficiently marked or not,
the definition factor: its value makes it possible to determine if the mark line made on the surface of the hollow glass article 8 is continuous or not. This value depends on the size of the spot, on the scanning speed and on the frequency of the laser 6.

The surface energy (J/mm²) is defined in the following way:

$$Surface energy = \frac{e nergy of a laser pulse \times frequency of the laser}{d i a meter of the laser spot \times scanning speed of the laser} \qquad [ Math . 1 ]$$

With:
the energy of a laser pulse in mJ,
the frequency of the laser in Hz, the diameter of the laser spot in microns,
the scanning speed of the laser 6 in mm/s.

The definition factor favours the sharpness of the decorations produced and gives information about the level of overlap of the impacts produced by the laser on the surface of the hollow glass articles 8. If the definition factor is very low, that is to say lower than 1, the groove produced on the surface of the hollow glass articles 8 by the laser 6 proves to be insufficiently smooth and even discontinuous. The experiment shows that this definition factor must be greater than or equal to 2.5 to obtain a well-defined decoration.

The definition factor is obtained with the following formula:

$$Definition factor of the decoration = \frac{d i a meter of the laser spot \times frequency of the laser}{s c a nning speed of the laser \times 1 , 000} \qquad [ Math . 2 ]$$

With:
the diameter of the laser spot in microns,
the frequency of the laser 6 in Hz,
the scanning speed of the laser 6 in mm/s.

The table below illustrates a few results of etchings obtained on the surface of hollow glass articles 8 the temperature of which is between 450 and 550° C. The experiments were performed with a lens of focal length 250 mm, a CO₂ laser of 125 W, a beam diameter of 14 mm (before focusing) and various values for each physical parameter thus making it possible to obtain more or less qualitative etchings.

TABLE 1

| Surface | | | |
|---|---|---|---|
| energy | Definition | Superficial energy of a | Appearance of the |
| (J/mm²) | factor | laser pulse (J/mm²) | etching on hot |
| 1.08 | 5.17 | 0.24 | Correct |
| 0.81 | 3.10 | 0.27 | Correct |
| Reference visual rendering | | | |
| 0.65 | 0.93 | 0.52 | Poor |
| 0.40 | 0.33 | 0.78 | Poor |
| 0.10 | 0.12 | 0.15 | Very poor |
| | | | (illegible) |

These various experiments prove that to obtain a correct marking on the hollow glass article, that is to say sufficiently marked and continuous, the value of the surface energy must be at least equal to 0.65 J/mm² and preferably at least equal to 0.80 J/mm², and the value of the definition factor must be strictly greater than 2.5.

The importance of the adjustment of the definition factor and of the surface energy of the laser 6 is also illustrated in FIGS. 3 and 4.

FIG. 3 shows an image obtained with a binocular magnifier of a marking of which the definition factor is 0.5 and the surface energy is 0.3 J/mm². The marking obtained is discontinuous and fairly shallow, which gives a not very aesthetic appearance to the etching.

FIG. 4 shows an image obtained with a binocular magnifier of a marking on a hollow glass article 8 produced by a laser 6 of which the definition factor is 5 and the surface energy is 1.1 J/mm2. The marking obtained is therefore of quality.

Consequently, the two physical parameters of the laser 6, that is to say the surface energy and the definition factor are complementary and to obtain an aesthetic and qualitatively satisfactory etching, it is essential that the two conditions are respected.

In the interest of productivity, it is vital that the scanning speeds of the laser beam are the highest possible, a speed greater than 1,000 mm/s generally proving to be required for the production of filiform extended decorations on the surface of the hollow glass article 8. It is therefore important to select a sufficient power of the laser 6 and pulses sufficiently close to obtain a satisfactory definition factor.

### Example 2: Adjustment of the Distance Between the Surface to be Treated and the Focal Plane of the Laser 6

FIGS. 5 to 7 show the quality of the marking depending on the distance between the lens and the surface to be treated for a temperature of the glass between 400° C. and 600° C. The depth of the marking directly impacts the final rendering of the etching on the hollow glass article 8.

FIG. 5 shows an image obtained with a binocular magnifier of a marking on a hollow glass article 8 produced by a laser 6, the surface to be treated being placed at the focal plane of the laser 6.

FIG. 6 shows an image obtained with a binocular magnifier of a marking on a hollow glass article 8 produced by a laser 6, the surface to be treated being placed at a distance of 10 mm in relation to the focal plane of the laser 6.

FIG. 7 shows an image obtained with a binocular magnifier of a marking on a hollow glass article 8 produced by a laser 6, the surface to be treated being placed at a distance of 12 mm in relation to the focal plane of the laser 6.

The laser marking results presented in FIGS. 5 and 6 are qualitatively satisfactory as opposed to the result presented in FIG. 7 that is not satisfactory.

Consequently, to obtain an aesthetic and quality etching, the distance between the surface to be treated and the focal plane of the laser 6 must be less than or equal to 10 mm.

### Example 3: Marking Space of the Laser 6 and Positioning of the Surface to be Treated of the Hollow Glass Article 8

For example, a Ftheta laser lens with a focal of 250 mm makes it possible to have a plane shot range of 170 mm×170 mm and a depth of field in the order of 20 mm. The complete system makes it possible to have a theoretical spot diameter at the focal plane of the laser 6 of 310 μm. The real diameter of the impacts on the glass will depend on the adjustment parameters of the laser 6, on the temperature of the surface of the glass, and on the lens/surface distance.

FIG. 8 illustrates the marking space of the laser 6 in the area dedicated to the marking step, on the conveyor 9, wherein the laser marking obtained is satisfactory. It was experimentally demonstrated that the result of the marking is homogeneous in a marking space thus extended (170 mm×170 mm×20 mm).

Such a marking space makes it possible to envisage homogeneous decorations on more or less complex surfaces travelling on a conveyor 9 and brought to a temperature between 400° C. and 600° C. This temperature range is valid for the glasses of the soda-lime, crystal, crystalline, borosilicate or fluorosilicate type.

FIGS. 9 and 10 illustrate the optimal position of a hollow glass article 8 in relation to the laser 6 during the marking step. The hollow glass article 8 is arranged in the area dedicated to the marking step, on the conveyor 9, the laser 6 defining a marking space (rectangular) such as presented in FIG. 8 and the focal plane of the laser 6 being in the middle of the marking space. The surface to be treated by the laser 6 of the hollow glass article 8 being the surface coinciding with the marking space of the laser 6.

Preferably, as can be seen in FIGS. 9 and 10, the hollow glass article 8 is positioned so that the focal plane of the laser 6 is in the middle of the surface to be treated by the laser 6 of the hollow glass article 8, according to the depth of the marking space of the laser 6.

### Example 4: Obtaining at Least One Continuous Groove Produced by the Laser 6

In order to characterise the markings, profile measurements were carried out on chromatic confocal optical bench. FIG. 11 is a sectional view of a groove on a hollow glass article 8 obtained by the laser marking step, the groove being defined as being a single line.

The parameters that characterise the quality of the laser marking (presented in FIG. 11) are the depth of the groove (b) produced by the laser 6, the width of the groove (c) produced on the surface of the hollow glass article 8, and the height of the two beads (a).

A qualitative marking is characterised by a groove depth between 25 and 30 μm, a groove width of 300 to 450 μm on the surface of the hollow glass article 8 and a bead height between 5 and 7 μm.

FIG. 12 is a front view of a hollow glass article likely to be obtained by the manufacturing method according to the invention. The hollow glass article 8 of FIG. 12 includes filiform decorations formed by a plurality of continuous grooves produced on the surface of the hollow glass article 8 during the marking step.

Of course, it is possible to combine this decorative marking method with decoration techniques already known and likely to cover, all or partially, the etchings previously made according to the invention, that is to say the surface metallisation or iridescence by CVD method, the deposition of precious metals by silkscreen printing and the application of shiny, satin, pearlised, metallised lacquers and varnishes.

1. Method for manufacturing a hollow glass article comprising the following steps:
hot forming the hollow glass article by means of a forming machine,
marking the hollow glass article thus formed by laser, the surface of the hollow glass article being at a temperature between 400° C. and 600° C., and
annealing the hollow glass article thus marked in an annealing lehr; wherein the marking step consists in making filiform decorations by producing at least one continuous and shiny groove on the surface of the hollow glass article, the groove being defined by a single line, and
wherein, prior to the marking step, the manufacturing method further includes a step of adjusting the laser consisting in adjusting the laser with the aid:
of a first parameter that is the definition factor, in such a way that the latter is greater than 2.5, the definition factor being defined as the ratio of the product of the diameter of the laser spot with the frequency of the laser and of the scanning speed of the laser, and
of a second parameter that is the surface energy, in such a way that the latter is greater than or equal to 0.65 J/mm2, the surface energy being defined as the ratio of the product of the energy of a laser pulse with the frequency of the laser and the product of the diameter of the laser spot with the scanning speed of the laser.

2. Manufacturing method according to claim 1, wherein the laser has a wavelength the rate of absorption of which by the surface of the hollow glass article is greater than 80%.

3. Manufacturing method according to claim 1, characterised in that wherein the step of adjusting the laser consists in adjusting the laser in such a way that the surface energy is greater than or equal to 0.80 J/mm².

4. Manufacturing method according to claim 1, wherein the hollow glass article is made of soda-lime glass.

5. Manufacturing method according to claim 1, wherein the hollow glass article is made of crystal glass, or crystalline, or borosilicate or fluorosilicate.

6. Manufacturing method according to claim 2, wherein the rate of absorption of the wavelength of the laser by the surface of the hollow glass article is greater than 90%.

7. Manufacturing method according to claim 1, wherein the laser is a CO2 laser.

8. Manufacturing method according to claim 1, wherein the hollow glass article is placed on a conveyor circulating from the forming step up to the annealing step.

9. Manufacturing method according to claim 8, wherein prior to the step of marking the hollow glass article, the manufacturing method includes a step of transferring the hollow glass article from the conveyor on ancillary equipment, and in that the marking step is performed on said ancillary equipment.

10. Manufacturing method according to claim 9, wherein the ancillary equipment comprises a carousel.

11. Hollow glass article likely to be obtained by the manufacturing method such as defined according to claim 1.

12. Hollow glass article according to claim 11, wherein the continuous and shiny groove produced by the laser on the surface of the hollow glass article has a depth between 25 and 30 μm, a width between 300 and 450 μm and two beads of a height between 5 and 7 μm.
